(19) United States
(12) Patent Application Publication
(10) Pub. No.: US 2017/0154531 A1
(43) Pub. Date: Jun. 1, 2017

(54) DRIVE SUPPORT APPARATUS

(71) Applicant: DENSO CORPORATION, Kariya-city (JP)

(72) Inventor: Junichiro FUNABASHI, Kariya-city (JP)

(21) Appl. No.: 15/356,744

(22) Filed: Nov. 21, 2016

(30) Foreign Application Priority Data
Nov. 30, 2015 (JP) 2015-232880

(51) Int. Cl. G08G 1/16; G01C 21/30

(52) U.S. Cl. CPC G08G 1/161; G01C 21/30

(57) ABSTRACT

A self-vehicle position obtainer in a driver support apparatus specifies a current position of a self-vehicle based on an output from a GNSS receiver and/or a vehicle speed sensor. A front intersection identifier identifies an intersection in front of the self-vehicle based on the current position of the self-vehicle and road map data, and an intersection area identifier identifies an intersection area. Then, an intersection in-or-out determiner determines whether the self-vehicle has entered into the intersection area. When the intersection in-or-out determiner has determined that the self-vehicle has entered into the intersection area, a collision estimator identifies a collidable car that possibly collides with the self-vehicle in the intersection that had been identified as the front intersection before an entrance of the self-vehicle thereinto, until the self-vehicle is determined as having exited from the intersection area.

### CROSS REFERENCE TO RELATED APPLICATION

The present application is based on and claims the benefit of priority of Japanese Patent Application No. 2015-232880, filed on Nov. 30, 2015, the disclosure of which is incorporated herein by reference.

### TECHNICAL FIELD

The present disclosure generally relates to a drive support apparatus for supporting a drive operation by a driver of a vehicle, by predicting a collision between vehicles.

### BACKGROUND INFORMATION

In recent years, a vehicle-to-vehicle communication system is proposed, in which each of many vehicles in the system exchanges information, i.e., (i) transmitting, or sending out, from a self-vehicle to other vehicles/cars in the system, self-vehicle information such as a travel speed, a current position, a travel direction and the like in a form of communication packets and (ii) receiving from the other vehicles/cars in the system the communication packets, as required.

Further, as an apparatus used in such vehicle-to-vehicle (i.e., V2V) communication system, various drive support apparatuses that provide a drive support for the driver are proposed by predicting a possibility of collision with other vehicles/cars based on vehicle information of the other vehicle/car (i.e., other car information, hereafter) obtained by the V2V communication system and vehicle information of the self-vehicle (i.e., self-vehicle information, hereafter).

For example, a patent document, Japanese Patent No. 5082349 (Patent Document 1), discloses a drive support apparatus that identifies (i.e., maps) a position of other car on the map based on position information of the other car obtained via the V2V communication, and predicts an intersection through which the other car is going to pass based on the current position, the travel direction, and the vehicle speed of the other car. Further, the drive support apparatus also predicts an intersection through which the self-vehicle is going to pass, by mapping the position of the self-vehicle on the map, and by using the current position, the travel direction and the vehicle speed of the self-vehicle. Note that such “mapping” is performed by using a well-known map matching method in the art.

In the above disclosure, in case that the other vehicle is predicted to pass the same intersection as the self-vehicle, a possibility of collision of the self-vehicle with the other car is determined based on a required time for the other car to reach the subject intersection. Then, if it is determined that the self-vehicle may possibly collide the other car, information about the other car is notified to the driver of the self-vehicle.

In the road map data, a position of an intersection is recorded as coordinates. A navigation apparatus of well-known type determines whether the self-vehicle has passed an intersection based on whether the self-vehicle has passed a position, i.e., the coordinates, of the subject intersection. In other words, when the coordinates of the subject intersection, or, the “intersection coordinates” of the subject intersection, are determined to have been passed, the self-vehicle is considered as having passed the intersection.

However, in reality, the subject intersection has a certain amount of area, e.g., a width of the road (i.e., a link, in a context of road map data) that is connected to the subject intersection, thereby causing a discrepancy between the data and the reality, i.e., the intersection coordinates having been passed by the self-vehicle based on the road map data may actually correspond to/indicate a situation in which the self-vehicle is still passing through, i.e., is traveling in, or exists in, the subject intersection.

In the patent document 1, the subject intersection for a determination about the collision possibility is set based on the mapping result of the self-vehicle and the other car. However, as described above, the mapping result may represent a false/wrong situation in which a still-in-the-intersection self-vehicle is considered as already having passed through (i.e., exited from) the subject intersection.

For example, if the self-vehicle still traveling in the subject intersection is considered as having passed through the subject intersection by the navigation apparatus, the subject intersection transits to the other, e.g., to the next, intersection from the currently-traveled intersection. Then, after such transition, or the switching of the intersections, the information to be notified to the driver/user from the navigation apparatus is also switched. That is, after such a “false” transition, the information also transitions to a “false” one.

For the driver/user traveling in, i.e., passing through, one intersection, the information of the next/other intersection is not so relevant, or, rather confusing. That is, providing the information of the next/other intersection should basically be avoided for the driver/user.

Further, other vehicle(s) may be more simply designated as other “car(s)” in the following description, which may make it easier for the self-vehicle to be distinguished from the other car(s).

### SUMMARY

It is an object of the present disclosure to provide a drive support apparatus that prevents a situation of providing false information to a driver/user in a vehicle that is passing a subject intersection for avoiding confusion.

In an aspect of the present disclosure, a drive support apparatus used in a self-vehicle includes a V2V communicator performing a vehicle-to-vehicle communication with other car that exists around the self-vehicle, a self-vehicle position specifier specifying a current position of the self-vehicle based on navigation signals transmitted from a navigation satellite, an other car information obtainer obtaining other car information indicative of a current position, a travel direction and a travel speed of the other car via the V2V communicator, a mapper identifying, e.g., mapping, a position of the self-vehicle on a road map that shows a connection relationship of roads based on the current position of the self-vehicle specified by the self-vehicle position specifier, a front intersection identifier, identifying a front intersection to be traveled by the self-vehicle based on an identification result of the mapper, an intersection area specifier, specifying an intersection area of the front intersection that is identified by the front intersection identifier, based on, for example, an area boundary of the front intersection, an intersection in-or-out determiner determining sequentially, or “as required”, whether the self-vehicle exists inside of the intersection area or outside of the intersection area of the front intersection based on a comparison between (i) the current position of the self-vehicle specified by the self-vehicle position specifier and (ii) the intersection area of the front intersection specified by the intersection area specifier, and a collidable car identifier identifying a collidable car that possibly collides with the self-vehicle in a specific intersection based on (i) the current position of the self-vehicle specified by the self-vehicle position specifier and (ii) the other car information obtained by the other car information obtainer. (A) The collidable car identifier identifies the collidable car in the front intersection, when the intersection in-or-out determiner is determines that the self-vehicle exists outside of the area boundary of the front intersection. Also, (B) the collidable car identifier identifies the collidable car in an intersection that has been identified as the front intersection by the front intersection identifier, when the intersection in-or-out determiner determines that the self-vehicle exists inside of the area boundary of the front intersection, at a timing before a determination by the intersection in-or-out determiner that the self-vehicle exists inside of the front intersection.

According to the above configuration, the front intersection in front of the self-vehicle is identified by the front intersection identifier as, for example, the area boundary of the intersection area, and whether the self-vehicle is in or out of the area boundary of the front intersection is determined by the intersection in-or-out determiner. The self-vehicle in the above indicates a vehicle using the drive support apparatus.

The collidable car identifier identifies a collidable car that may possibly collide with the self-vehicle in the front intersection when the self-vehicle exists outside of the area boundary of the front intersection. Then, after the entrance of the self-vehicle into the inside of the front intersection, the collidable car identifier identifies the collidable car in an intersection that has been identified as the front intersection by the front intersection identifier at a timing before a determination by the intersection in-or-out determiner that the self-vehicle exists inside of, for example, the area boundary of the front intersection. In other words, during a period of passing of the self-vehicle through the front intersection, i.e., after an entrance thereinto until an exit therefrom, the collidable car identifier identifies the collidable car in the front intersection that has already been determined, i.e., considered, as the front intersection at a timing before an entrance of the self-vehicle thereinto.

Therefore, according to the above, while passing through a certain intersection, the collidable car identifier is prevented from performing the collidable car identification process for identifying a collidable car in a different intersection that is different from a currently-passing intersection. That is, even if the drive support apparatus is configured to notify to the user/driver of the self-vehicle the information about the collidable car that has been identified by the collidable car identifier, the information notified to the user/driver is prevented, or is less likely, from being switched from the one about the collidable car in the front intersection to the one about the collidable car in a different intersection. In other words, the confusion of the user/driver of the self-vehicle that is passing through an intersection is prevented.

The numerals in parentheses in the claims exemplarily show a relationship between the concrete components in the following embodiments and the claim elements, thereby not limiting the technical scope of the present disclosure in any manner.

### BRIEF DESCRIPTION OF THE DRAWINGS

Objects, features, and advantages of the present disclosure will become more apparent from the following detailed description made with reference to the accompanying drawings, in which:

FIG. 1 is a block diagram of an in-vehicle system in one embodiment of the present disclosure;

FIG. 2 is a block diagram of a controller in the in-vehicle system in the one embodiment of the present disclosure;

FIG. 3 is an illustration of an intersection area;

FIG. 4 is another illustration of the intersection area;

FIG. 5 is a flowchart of a drive support process performed by the controller;

FIG. 6 is a flowchart of an outside-intersection collision estimation process;

FIG. 7 is an illustration of a self-vehicle predicted travel path and an other car predicted travel path;

FIG. 8 is a diagram of relationship between a travel path crossing angle and a collision type; and

FIG. 9 is an illustration of the intersection area in a modification of the present disclosure.

### DETAILED DESCRIPTION

### Embodiment

Hereafter, one embodiment of the present disclosure is described using the drawings.

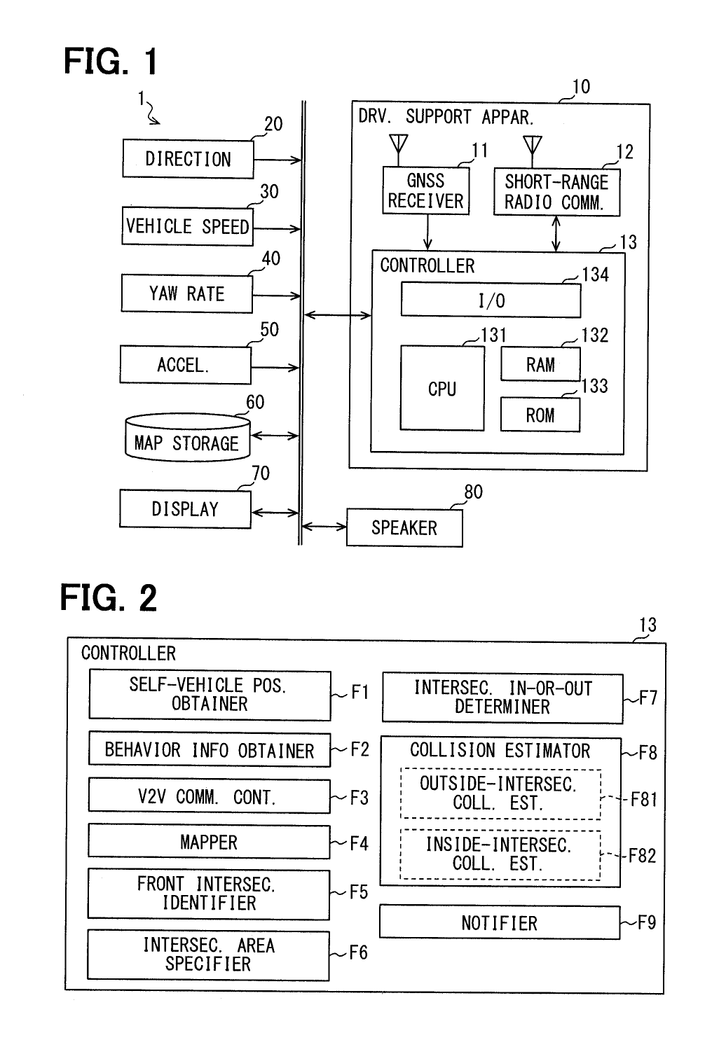

FIG. 1 is a block diagram of an example configuration of an in-vehicle system 1 provided with the functions that serve as a drive support apparatus concerning the present disclosure. The in-vehicle system 1 is disposed in each of plural vehicles traveling on the road. For the ease of the description, a “self-vehicle” in the following indicates a vehicle on which the subject in-vehicle system 1 is disposed, and “other car” indicates a vehicle that is different from the self-vehicle having such in-vehicle system 1.

<Configuration of the In-Vehicle System 1>

The in-vehicle system 1 is provided with a drive support apparatus 10, a direction sensor 20, a vehicle speed sensor 30, a yaw rate sensor 40, an acceleration sensor 50, a map storage 60, a display 70, and a speaker 80 as shown in FIG. 1.

The drive support apparatus 10 is connected with other devices in the vehicle via a local network (henceforth, LAN: Local Area Network) built in the vehicle, such as the direction sensor 20, the vehicle speed sensor 30, the yaw rate sensor 40, the acceleration sensor 50, the map storage 60, the display 70, and the speaker 80 for the communication therewith.

The drive support apparatus 10 is provided with, as more-in-detail components, a GNSS receiver 11, a short-range radio communicator 12, and a controller 13.

The GNSS receiver 11 receives navigation signals which are transmitted from the navigation satellites of the Global Navigation Satellite System (GNSS), and sequentially calculates the current position based on the received navigation signal.

The position information showing the current position may at lease be represented by latitude, longitude, and altitude, for example. The “sequential” controller 13 (i.e., the sequential controller) is provided with such position information showing the current position which is calculated by the GNSS receiver 11.

The short-range radio communicator 12 is a communication module for performing (i) a vehicle-to-vehicle communication to/from the short-range radio communicator disposed in other cars and (ii) a road-to-vehicle communication between a vehicle and a road-side device disposed on a road side, by using the electric wave of the predetermined frequency bands, e.g., 5.9 GHz bands and 760 MHz bands.

The short-range radio communicator 12 sequentially provides data to the controller 13 after receiving the data from other cars or from the road-side device. Further, the short-range radio communicator 12 transmits the data inputted from the controller 13 at any time.

Since the short-range radio communicator 12 can perform the vehicle-to-vehicle communication, it is equivalent to a vehicle-to-vehicle communicator of the claims.

For example, the short-range radio communicator 12 receives a communication packet including vehicle information of the other car while transmitting a communication packet including the vehicle information that shows a travel state of the self-vehicle.

The vehicle information includes information such as a current position, a travel direction, a vehicle speed, acceleration, and the like. Besides including the vehicle information, the communication packet also includes a transmission time of the communication packet, and sender information of the packet. The sender information may be an identification number that is assigned to a vehicle from which the vehicle information is transmitted (i.e., a vehicle ID of a sender vehicle).

The controller 13 is provided as a well-known computer, for example, and has a CPU 131, a RAM 132, a ROM 133, an Input-Output (I/O) 134, and a bus line that connects these components and the like. CPU in this case represents a Central Processing Unit, RAM represents a Random Access Memory, and ROM represents a Read Only Memory.

The CPU 131 may be implemented as a microprocessor or the like. The RAM 132 is a volatile memory and the ROM 133 is a non-volatile memory. The ROM 133 stores a program that controls the well-known computer to function as the controller 13. The program may thus be designated as a drive support program henceforth.

The I/O 134 is an interface for data input/output for the controller 13, i.e., to input data from and output data to the GNSS receiver 11, the short-range radio communicator 12 and/or the other devices including many sensors via LAN. The I/O 134 may be implemented as an analog circuit element, or as an IC, etc.

The above-mentioned drive support program may at least be stored in a non-transitory tangible storage medium. Execution of the drive support program by the CPU 131 is equivalent to a performance of a method that corresponds to the drive support program.

The controller 13 estimates, in substance, a possibility of collision of the self-vehicle with the other car that exists at a proximity of, i.e., around, the self-vehicle based on the data inputted from the GNSS receiver 11 or from the short-range radio communicator 12. Then, based on the result of such estimation, the controller 13 provides the information for avoiding the collision with the other car to a driver of the self-vehicle by operating the display 70 and/or the speaker 80 in the predetermined manner. The details of the operation of the controller 13 are mentioned later. The other cars existing around the self-vehicle are the other cars performing the vehicle-to-vehicle communication with the self-vehicle.

The direction sensor 20 is a sensor for detecting an absolute direction of the self-vehicle, which may be, for example, a magnetic field sensor or the like.

The vehicle speed sensor 30 detects a vehicle speed of the self-vehicle.

The yaw rate sensor 40 detects a rotational angle speed about the vertical axis of the self-vehicle.

The acceleration sensor 50 detects an acceleration of the self-vehicle along a travel direction of the self-vehicle. In addition to the above, the acceleration sensor 50 may also detect the acceleration along the lateral, i.e., vehicle-width, direction, and/or along the vehicle height direction.

The detection result of the direction sensor 20, the vehicle speed sensor 30, the yaw rate sensor 40, and the acceleration sensor 50 are sequentially provided for the drive support apparatus 10 via LAN.

The map storage 60 stores the road map data in which road connection data representing a network of the roads and road shape data representing a shape of the road are stored as the data together with other attributes of the road.

The road map data stored in the map storage 60 represents the road network by using node information and link information. The node information is information about the “nodes” which may be the connection points of the two roads. The node may be an intersection of the road. The node information of an intersection includes coordinate information which shows the position of the intersection, and information about the road(s) connected to the intersection concerned.

The link information is information about the “links” that serve as linking elements between the nodes. The link information may include lane information indicating the number of traffic lanes in the link concerned.

The display 70 displays various types of information based on the instructions from the drive support apparatus 10. The display 70 may be implemented as a liquid crystal display device, as an organic electroluminescence display device, or the like. The display 70 may at least be arranged at a position which is visible from the driver's seat of the self-vehicle. A Head Up Display (HUD) may be used as the display 70.

The speaker 80 outputs various types of sound to a vehicle compartment of the self-vehicle based on the instructions from the drive support apparatus 10.

<Function of the Controller 13>

The functions of the controller 13 are described with reference to FIG. 2. The controller 13 provides functions corresponding to each of the various functional blocks shown in FIG. 2, when the CPU 131 executes the above-mentioned drive support program.

More specifically, the controller 13 is provided with the following function blocks, i.e., a self-vehicle position obtainer F1, a behavior information obtainer F2, a V2V communication controller F3, a mapper F4, a front intersection identifier F5, an intersection area specifier F6, an intersection in-or-our determiner F7, a collision estimator F8, and a notifier F9 respectively as a functional block.

Some or all of the functional blocks of the controller 13 may be realized as hardware, e.g., by using one or more Integrated Circuits (ICs).

Some or all of the functional blocks of the controller 13 may be realized as a combination of hardware and software, i.e., by the execution of software by the CPU.

The self-vehicle position obtainer F1 obtains the current position of the self-vehicle from the GNSS receiver 11.

The self-vehicle position obtainer F1 in the present embodiment may also perform a dead-reckoning process that estimates the current position by using the detection value of the direction sensor 20 and/or the vehicle speed sensor 30 and the like.

The self-vehicle position obtainer F1 is equivalent to the self-vehicle position specifier in the claims.

The behavior information obtainer F2 obtains the behavior information which shows the action/behavior of the self-vehicle from the various sensors, e.g., from the direction sensor 20, the vehicle speed sensor 30, the yaw rate sensor 40, the acceleration sensor 50 and the like.

That is, the behavior information obtainer F2 obtains the current travel direction, the vehicle speed, the yaw rate, the acceleration, etc. as behavior information.

The information included in the behavior information may contain not only the information mentioned above but also other information, such as an operation state of the blinkers, the shift position (i.e., a position of the gear), the amount of depression of the brake pedal, for example, the amount of depression of the accelerator pedal, etc.

Based on the current position of the self-vehicle, which is obtained by the self-vehicle position obtainer F1 and the behavior information, which is obtained by the behavior information obtainer F2, the V2V communication controller F3 generates the vehicle information (henceforth, self-vehicle information) of the self-vehicle sequentially, e.g., at every 100 milliseconds, and outputs the self-vehicle information to the short-range radio communicator 12.

Thereby, the short-range radio communicator 12 transmits sequentially the communication packet indicative of the self-vehicle information to the surrounding of the self-vehicle (i.e., broadcasts the communication packet).

The V2V communication controller F3 obtains the vehicle information (henceforth, other car information) of the other car, which is transmitted from the other car and is received by the short-range radio communicator 12, from the short-range radio communicator 12.

The V2V communication controller F3 associates the received vehicle information from the other car with a vehicle ID of the sender vehicle, and saves the information to the RAM 132.

In such manner, the V2V communication controller F3 distinguishes and manages the information about each of the other cars existing at a proximity of the self-vehicle.

The V2V communication controller F3 obtaining the other car information is equivalent to an other car information obtainer in the claims.

The mapper F4 identifies the position of the self-vehicle on the map data which is stored by the map storage 60 based on (i) the current position identified by the self-vehicle position obtainer F1 and (ii) the travel direction obtained by the behavior information obtainer F2.

Henceforth, identification of the vehicle position on the road map may also be designated as “mapping” of the vehicle position on the road map by using the map data.

The “mapping” of the vehicle position may simply be performed by using a well-known “map matching” technique commonly used in the art of the navigation device. The map matching technique identifies the current position of the vehicle based on (i) the calculation of the travel path of the vehicle from the travel direction and the vehicle speed at several timings and (ii) the comparison between the travel path of the vehicle and the road shape derived from the map information.

Further, the mapper F4 identifies a road that is traveled by the self-vehicle (henceforth, a self-vehicle travel road) based on the result of mapping of the self-vehicle. Then, the map data about the self-vehicle travel road concerned (henceforth, proximity map data) is extracted from the map storage 60, and is saved to the RAM 132.

The proximity map data may at least include the information on the intersections existing in the travel direction of the self-vehicle, and the link connected to such intersections.

The identification result by the mapper F4 includes, as a result of “mapping”, the current position of the self-vehicle on the map and the self-vehicle travel road on the map.

The front intersection identifier F5 identifies the next intersection that is in the travel direction of the self-vehicle on the self-vehicle travel road identified by the mapper F4 with reference to the proximity map data, i.e., a “front intersection”. The front intersection identified by the front intersection identifier F5 serves as a “subject intersection” in the following processes, e.g., for a process by the collision estimator F8 for determining a possibility of collision of the self-vehicle with the other car, and for a process by the notifier F9 for notifying the determined collision possibility.

The intersection area specifier F6 specifies an intersection area Ar1 for the front intersection, which is identified by the front intersection identifier F5, as a certain portion of the road having a width and a depth.

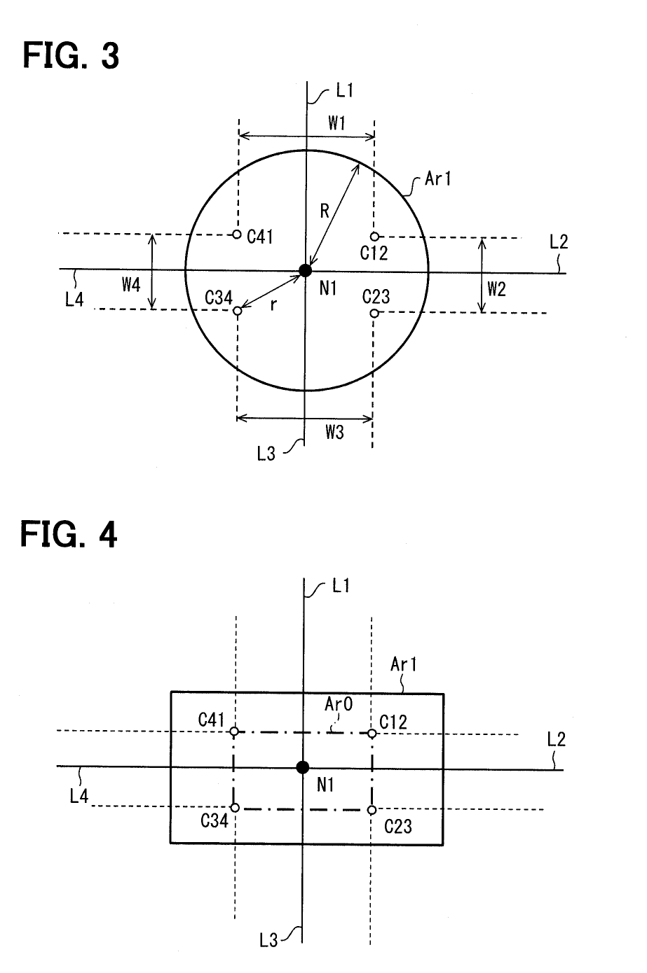

For example, the intersection area Ar1 may be defined as a circular area within a circle, which centers on a node N1 having certain node coordinates and representing the front intersection with the radius of R, including the boundary line, as shown in FIG. 3.

In FIG. 3, N1 represents a node equivalent to the front intersection, and each of L1-L4 represents a link that is connected to the node N1. Further, each of W1-W4 represents the width of each link, and the dashed line in the drawing represents the edge (henceforth, a road edge) of the road corresponding to each link, defining the width of the road. The width of the road is preferably a width of a travel area of the road within which the vehicle travels on the road.

Further, the radius R may be determined in the following manner, for example. That is, two road edges defining the width of the road, e.g., road edges for the link L1, intersect with the other two road edges for the links L2/L4, at points C12 and C41, as shown in FIG. 3. Likewise, points C23 and C34 are defined as intersection of the road edges for the link L3 and the road edges for the link L2/L4. Then, a distance from the node N1 to each of the points C12, C23, C34, C41 is calculated, and the maximum distance among the four distances is used as a temporary radius R0.

Then, the radius R may be set to a value that is derived by multiplying the temporary radius R0 by a certain coefficient α. The coefficient α may preferably be equal to or greater than 1. The determination method of the radius R may be different from the above, with a reservation that the shape of the intersection area and the radius R of the intersection area may be arbitrary as long as the intersection area practically serves/is workable as an intersection area. Further, the above example of the intersection having four links connected thereto may be modified to have three connecting links or five or more connecting links, which is processable in the same manner.

Further, the circular shape of the intersection area Ar1 described in the above may be modified to a different shape, e.g., to a square shape as shown in FIG. 4, in which the area Ar1 is defined as a similar to a rectangle that centers on the node N1 and is defined by the four points C12, C23, C34, C41. The magnification rage β of the area Ar1 against the area Ar0 may be any value as long as the rate β is equal to or greater than 1. The area Ar0 corresponds to an actual intersection area used in practice, and the magnification rate p is a coefficient for absorbing the positioning error, e.g., is a value of 1.2 or the like.

Further, the intersection area Ar1 may be simply set up in a manner that is described in modification 6 in the following.

Further, the data defining the intersection area Ar1 may be registered for each of the nodes representing an intersection to the ROM 133 or to the map storage 60. In such case, the intersection area specifier F6 may read the data defining the intersection area Ar1 corresponding to the front intersection that is identified by the front intersection identifier F5 from the ROM 133 or from the map storage 60.

The intersection in-or-our determiner F7 compares the current position specified by the self-vehicle position obtainer F1 with the intersection area Ar1 specified by the intersection area specifier F6, and determines sequentially whether the self-vehicle exists in an inside of the intersection area Ar1, or the outside thereof.

That is, when the current position of the self-vehicle is an inside of the intersection area Ar1, it is determined that the self-vehicle exists inside of the intersection area Ar1, and, when the current position of the self-vehicle is an outside of the intersection area Ar1, it is determined that the self-vehicle exists outside of the intersection area Ar1.

The intersection in-or-our determiner F7 determines that the self-vehicle has entered into the intersection area Ar1 of the front intersection, when the self-vehicle shifts from a first state to a second state: the first state determined as the self-vehicle existing outside of the intersection area Ar1 and the second state determined as the self-vehicle existing inside of the intersection area Ar1.

Further, when the self-vehicle shifts from the second state to a third state, intersection in-or-our determiner F7 determines that the self-vehicle has exited from the intersection area Ar1: the third state determined as the self-vehicle existing outside of the intersection area Ar1.

The entrance into and the exit from the intersection area Ar1 means that the self-vehicle has entered/exited into/from the front intersection.

The collision estimator F8 is a function block that estimates a possibility of a collision of the self-vehicle with the nearby other car in the front intersection based on the current position of the self-vehicle, the behavior information of the self-vehicle, and the other car information that are obtained by the V2V communication controller F3.

In other words, the collision estimator F8 is a function block that identifies an other car that possibly collides with the self-vehicle. The collision estimator F8 is equivalent to a collidable car identifier in the claims.

The collision estimator F8 has, as more-in-detail function blocks, an outside-intersection collision estimator F81 and an inside-intersection collision estimator F82.

The outside-intersection collision estimator F81 performs a collision estimation process that estimates a collision possibility of the self-vehicle when the self-vehicle is determined as existing outside of the intersection area Ar1 by the intersection in-or-our determiner F7.

The inside-intersection collision estimator F82 performs a collision estimation process that estimates a collision possibility of the self-vehicle when the self-vehicle is determined as existing inside of the intersection area Ar1 by the intersection in-or-our determiner F7.

The details of the operation/calculation of the collision estimator F8 including the outside-intersection collision estimator F81 and the inside-intersection collision estimator F82 are mentioned later.

The notifier F9 collaborates with the display 70 and/or the speaker 80 to perform a notification process that notifies, to the driver of the self-vehicle, the information about the other car that possibly collides with the self-vehicle based on the estimation result of the collision estimator F8.

For example, the notifier F9 displays an image and/or a text for notifying an approaching direction of the colliding other car on the display 70.

Further, the notifier F9 may be configured to output a voice message that indicates the approaching direction of the colliding other car that may collide with the self-vehicle, etc. together with the information about the other car from the speaker 80.

Even in such manner, the same effects as the notification process by using the display 70 are achievable.

Notification device for notifying the information to the driver of the self-vehicle is not limited only to the display 70 nor to the speaker 80. The notification device may also be, for example, an indicator that uses LED etc., a vibrator or the like.

<Drive Support Process>

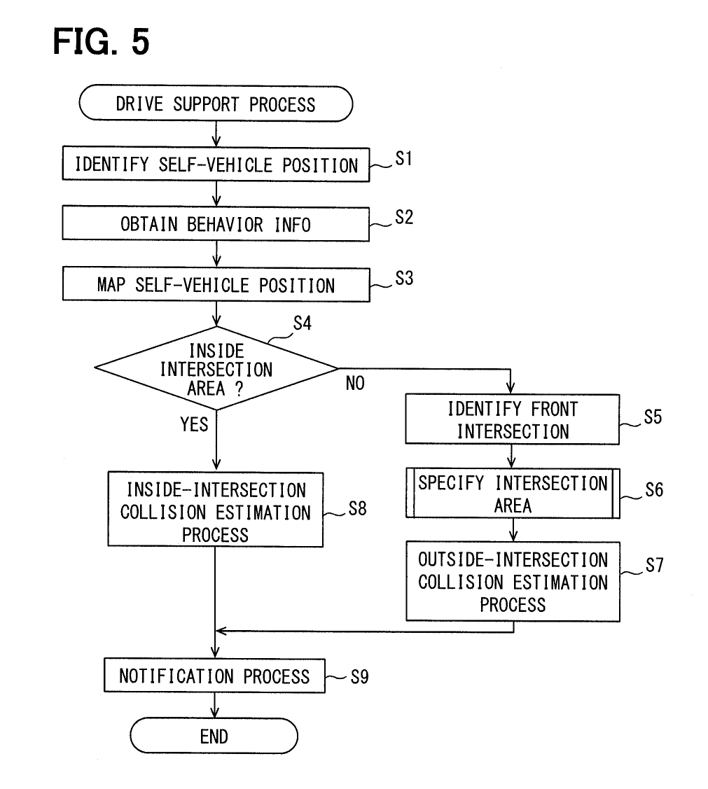

Next, the drive support process performed by the controller 13 is described with reference to a flowchart shown in FIG. 5.

The drive support process in the present embodiment is a series of processing for identifying the other car that possibly collides with the self-vehicle in the front intersection and for notifying the information about the other car concerned to the driver.

Henceforth, the other car that is identified in the drive support process may also be a collidable car. The flowchart shown in FIG. 5 may at least be periodically performed at an interval of, for example, 100 millisecond) while the electric power is supplied to the drive support apparatus 10.

First, in Step S1, the self-vehicle position obtainer F1 identifies the current position of the self-vehicle, and the process proceeds to Step S2.

The current position of the self-vehicle may be, for example, a position that is provided as the position information from the GNSS receiver 11 as it is (i.e., without change), or may be a corrected position that is corrected from the position information from the GNSS satellite by using the detection values of the direction sensor 20, the vehicle speed sensor 30 and the like.

In Step S2, the behavior information obtainer F2 obtains the behavior information of the self-vehicle, and the process proceeds to Step S3.

In Step S3, based on the current position identified in Step S1 and the travel direction included in the behavior information obtained in Step S2, the mapper F4 maps the current position of the self-vehicle, and the process proceeds to Step S4. In addition, the mapper F4 identifies the self-vehicle travel road. When the proximity map data has not yet been obtained, the proximity map data is obtained.

In Step S4, the intersection in-or-our determiner F7 determines whether the current position of the self-vehicle is inside of the intersection area Ar1 that is specified by the intersection area specifier F6 based on the current position of the self-vehicle identified in Step S1.

When the current position of the self-vehicle is not inside of the intersection area Ar1, Step S4 is negatively determined, and the process proceeds to Step S5. On the other hand, when the current position is inside of the intersection area Ar1, Step S4 is affirmatively determined, and the process proceeds to Step S8.

In case that the intersection area Ar1 has not yet been specified by the intersection area specifier F6, Step S4 is negatively determined and the process proceeds to Step S5.

In Step S5, the front intersection identifier F5 identifies the front intersection with reference to the proximity map data based on the result of mapping in Step S3, and the process proceeds to Step S6.

In Step S6, the intersection area specifier F6 specifies the intersection area Ar1 of the front intersection, and the process proceeds to Step S7. The data representing the intersection area Ar1 is stored in the RAM 132.

Note that, if (i) the front intersection identified in Step S5 is the same as the front intersection identified in the previously-executed drive support process and (ii) the intersection area Ar1 of the front intersection has already been specified, Step S6 may be skipped and the process proceeds to Step S7.

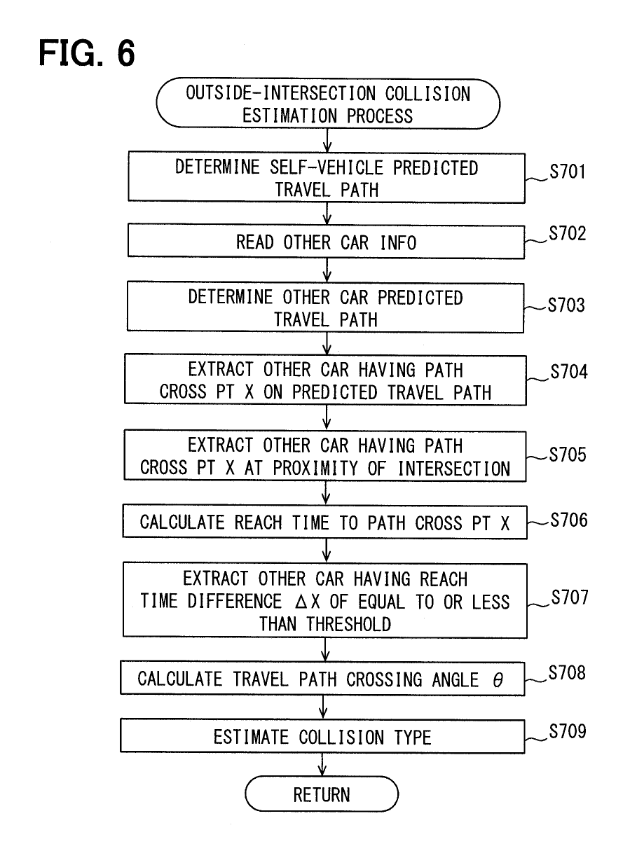

In Step S7, the outside-intersection collision estimator F81 performs an outside-intersection collision estimation process, and the process of the flowchart is finished. The outside-intersection collision estimation process is described with reference to FIG. 6.

The flowchart shown in FIG. 6 may at least be started when the process proceeds to Step S7 of FIG. 5. Each of the steps in the outside-intersection collision estimation process is performed by the outside-intersection collision estimator F81.

In substance, the process from Step S701 to Step S707 is equivalent to the process for extracting the collidable car colliding the self-vehicle from among the other cars that perform the vehicle-to-vehicle communication. Further, Step S708 and thereafter are the process for estimating the collision type between the collidable car and the self-vehicle.

A self-vehicle predicted travel path Ph is determined in Step S701. The self-vehicle predicted travel path Ph is a travel path predicted to be traveled by the self-vehicle in the future.

The self-vehicle predicted travel path Ph in the present embodiment is a half-line extending in the travel direction of the self-vehicle obtained in Step S2 from a starting point of the current position obtained in Step S1. When the process in Step S701 is complete, the process proceeds to Step S702. The collision estimator F8 that performs Step S701 is equivalent to a collidable car identifier in the claims.

In Step S702, the other car information stored in the RAM 132 is read for each of the other cars, and the process proceeds to Step S703.

In Step S703, the other car predicted travel path Pr is determined for each of the other cars that perform the vehicle-to-vehicle communication with the self-vehicle. The other car predicted travel path Pr of a certain other car is a travel path predicted to be traveled by that certain other car in the future.

In the present embodiment, the other car predicted travel path Pr about a certain other car is specified, for example, based on the newest current position and the travel direction of the other car concerned. More specifically, starting from the current position, a half-line is defined along the travel direction which serves as the other car predicted travel path Pr of the other car concerned. After calculating the path Pr for all of the other cars that perform the vehicle-to-vehicle communication with the self-vehicle, the process proceeds to Step S704.

The collision estimator F8 that performs Step S703 is equivalent to a collidable car identifier in the claims.

Although the travel path of each car is predicted as a half-line in the present embodiment, the predicted travel path may take a different shape. For example, the self-vehicle predicted travel path Ph may take an arc shape starting from the current position of the self-vehicle and tangential to a line that defines a front-rear direction of the self-vehicle.

The front-rear direction line of the self-vehicle is a line along the travel direction of the self-vehicle, and a radius of the arc shape is a value that is derived by dividing the vehicle speed of the self-vehicle by the yaw rate. That is, the shape of the self-vehicle predicted travel path Ph may be an arc shape that has a turning radius of the self-vehicle determined by the vehicle speed and the yaw rate of the self-vehicle. The other car predicted travel path Pr may similarly be an arc shape that has a turning radius of the other car determined by the vehicle speed and the yaw rate of the other car.

In Step S704, one or more of the other cars are extracted from among all of the other cars in communication with the self-vehicle via the vehicle-to-vehicle communication, based on a condition that the other car predicted travel path Pr intersects the self-vehicle predicted travel path Ph (S704: EXTRACT OTHER CAR HAVING PATH CROSS POINT X ON PREDICTED TRAVEL PATH).

In other words, the other cars around the self-vehicle with their predicted travel paths Pr not intersecting the self-vehicle predicted travel path Ph are excluded from a population, i.e., candidates, of the collidable car. Note that, when the flowcharted process in FIG. 6 is started, all other cars communicating with the self-vehicle via the vehicle-to-vehicle communication are the candidates (i.e., population) of the collidable car.

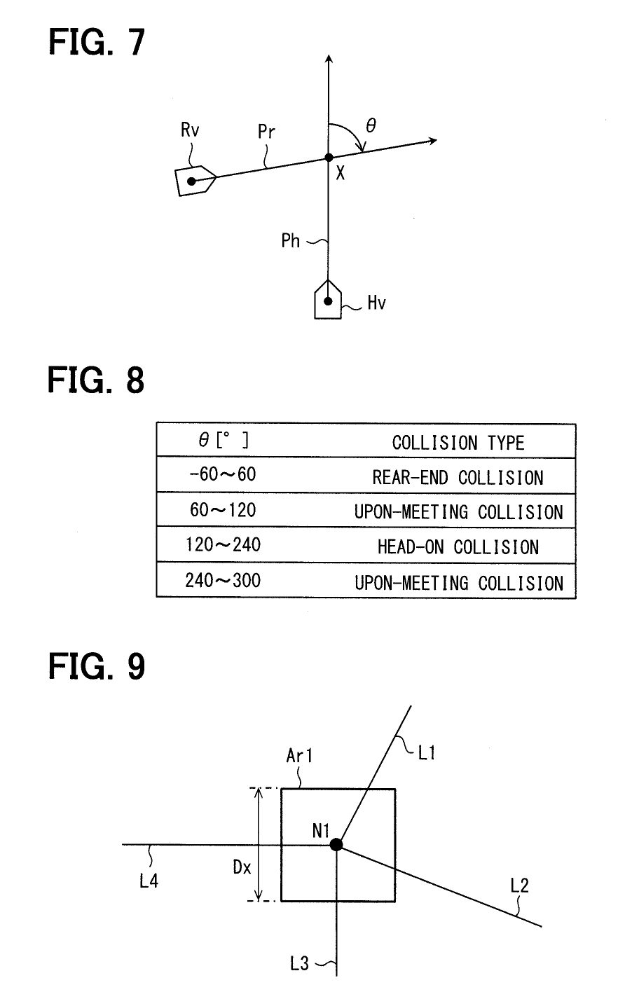

FIG. 7 illustrates a situation in which the other car predicted travel path Pr of a certain other car Rv and the self-vehicle predicted travel path Ph of a self-vehicle Hv intersect with each other.

Hv in FIG. 7 represents the self-vehicle, and a point X represents a point of intersection of the path Pr and the path Ph (henceforth, a path cross point X). The path cross point X is a point at which the travel path of an other car and the travel path of the self-vehicle cross with each other when both of the other car Rv and the self-vehicle Hv maintain the current travel direction.

Other cars not forming the path cross point X are excluded from the population of the collidable car, since such other cars would not collide with the self-vehicle.

Further, if the other car that forms the path cross point X is not found in Step S704, the flowcharted process is finished. The other car extracted in Step S704 is designated as a first extracted car, for the ease of naming. The position coordinates of the path cross point X for each of the other cars is stored in association with the other car that forms the relevant path cross point X.

In Step S705, when a node distance is defined as a distance from the path cross point X to the node corresponding to the front intersection, from among the first extract cars, the one having a node distance less than a threshold is extracted (FIG. 6:S705 EXTRACT OTHER CAR HAVING PATH CROSS POINT X AT PROXIMITY OF INTERSECTION). In other words, from among the first extract cars, the one having a node distance being equal to or greater than the threshold is excluded from the population of the collidable car candidates.

The above extraction is based on a reasoning that, in case that both of the self-vehicle and the other car are traveling toward the same intersection (i.e., toward the front intersection), the path cross point X highly possibly exists at the proximity of the front intersection. Therefore, when the path cross point X is far from the front intersection, the other car forming such a path cross point X is considered as not traveling toward or not passing through the front intersection. The threshold for the above extraction may be, for example, 10 meters or the like. The other car extracted in Step S705 is designated as a second extract car.

In case that the number of the second extract cars after Step S705 is equal to 0, the flowcharted process is finished.

In Step S706, time to reach the path cross point X is calculated for each of the second extract cars. The time calculated in the above may be designated as an other car reach time, hereafter. Further, for each of the path cross points X, time to reach the path cross point X is calculated for the self-vehicle, which is designated as a self-vehicle reach time.

The other car reach time about a certain other car may be calculated by the following procedure, for example.

First, regarding a subject other car for the calculation process of the other car reach time, a distance from the current position to the path cross point X is calculated based on the current position of the subject other car and the coordinates of the point X. The calculated distance from the above is then divided by the current vehicle speed of the subject other car is adopted as the other car reach time.

Then, the self-vehicle reach time to reach the relevant path cross point X is also calculable by the same procedure. That is, the distance from the current position of the self-vehicle to the path cross point X is calculated based on the current position of the self-vehicle and the coordinates of the path cross point X, and a value derived from dividing the calculated distance by the current vehicle speed of the self-vehicle is adopted as the self-vehicle reach time to reach the relevant path cross point X.

Then, for each of the second extract cars, a reach time difference ΔT between the other car reach time of the second extract car and the self-vehicle reach time to reach the relevant path cross point X is calculated.

The reach time difference ΔT that is calculated as a difference between the other car reach time of a certain (i.e., subject) second extract car and the self-vehicle reach time of the self-vehicle is stored in association with the subject second extract car.

When the process in Step S706 is complete, the process proceeds to Step S707.

In Step S707, from among the second extract cars, the one having the reach time difference ΔT equal to or less than a threshold is extracted. The threshold in this case may be a value of few seconds, for example, for a determination of possibility of collision between the other car and the self-vehicle in the course of passing through the path cross point X.

The other car extracted in Step S707 is a collidable car. When the number of the extracted other cars having the reach time difference ΔT of equal to or less than the threshold is equal to 0 after Step S707, the flowcharted process is finished. When Step S707 is complete, the process proceeds to Step S708.

In Step S708, a travel path crossing angle θ is calculated for each of the collidable cars. The travel path crossing angle θ about a certain other car that serves as a collidable car is an angle, as shown in FIG. 7, between the other car predicted travel path Pr of the other car concerned and the self-vehicle predicted travel path Ph.

The travel path crossing angle θ may be, for example, calculated as a positive angle value with reference to the self-vehicle predicted travel path Ph, i.e., a clockwise-measured angle from the path Ph toward the other car predicted travel path Pr. In such case, a counter-clockwise-measured angle is designated as a negative value. The angle formed at the path cross point X may at least be calculated by using a well-known mathematical technique. The travel path crossing angle θ functions as an index indicative of the approaching direction of the collidable car relative to the self-vehicle. The travel path crossing angle θ is stored in the RAM 132 for each of the collidable cars in association with the relevant other car that is used for the angle calculation.

When the process in Step S708 is complete, the process proceeds to Step S709.

In Step S709, a collision type is estimated for each of the collidable cars based on the travel path crossing angle θ corresponding to the other car concerned. The collision type may be estimated in the following manner, for example.

First, as the preparation of estimation of the collision type, data indicative of a relationship between the path cross angle θ and the collision type is registered to, i.e., prepared in, the ROM 133 or the like (henceforth, collision type estimation data). The collision type estimation data stored in the ROM 133 may at least be read by the CPU 131 with the help of the RAM 132.

FIG. 8 shows an example of a relationship between the travel path crossing angle θ and the collision type.

In the present embodiment, as shown in FIG. 8, when the travel path crossing angle is greater than −60 degrees and is less than 60 degrees, the collision type is determined as a rear-end collision. When the travel path crossing angle (a) is equal to or greater than 60 degrees and is equal to or less than 120 degrees or (b) is equal to or greater than 240 degrees and is equal to or less than 300 degrees, the collision type is determined as an upon-meeting collision. When the travel path crossing angle is greater than 120 degrees and is less than 240 degrees, the collision type is determined as a head-on collision.

The head-on collision is a collision of the self-vehicle and an on-coming vehicle, that approaches the self-vehicle in the opposite traffic lane. More practically, the self-vehicle and the on-coming vehicle may make a head-on collision when the self-vehicle traverses the opposite traffic lane to make a left turn (in USA, or in a country of “right-side traffic”) or to make a right turn (in Japan, or in a country of “left-side traffic”). The above description is only one example of the head-on collision, and the head-on collision is not necessarily limited to the above.

After completing a determination of the collision type in Step S709, the flowcharted process is finished, and the process proceeds to Step S9 of FIG. 5. Note that the information about the collidable car that is identified by the collision estimator F8 (i.e., more specifically, by the outside-intersection collision estimator F81) in the above-described process is held/stored in the RAM 132 or the like.

The information about the collidable car in the present embodiment may include, for example, a vehicle ID of the other car, i.e., of the collidable car, the approaching direction toward the self-vehicle, the collision type regarding the collision with the self-vehicle, the remaining time to the collision, etc., for example. Note that the remaining time to the collision with a certain collidable car may be, for example, (i) the self-vehicle reach time to the path cross point X corresponding to the collidable car concerned, or (ii) an average of the other car reach time corresponding to the collidable car concerned and the self-vehicle reach time.

Now the rest of the flowchart in FIG. 5, i.e., Step S8 and Step S9, is described.

In Step S8, the inside-intersection collision estimator F82 performs an inside-intersection collision estimation process, and the process proceeds to Step S9. The inside-intersection collision estimation process of Step S8 is a process that is performed when the intersection in-or-our determiner F7 determines that the current position of the self-vehicle is inside of the intersection area Ar1 in Step S4.

The inside-intersection collision estimation process that is performed by the inside-intersection collision estimator F82 is a process that is performed, when the self-vehicle exists in the intersection area Ar1, (a) for identifying the collidable car in an intersection that corresponds to the intersection area Ar1 concerned and (b) for estimating the collision type regarding the collision between the self-vehicle and the other car.

In the present embodiment, for example, the inside-intersection collision estimator F82 adopts, as the information about a current situation around, i.e., at the proximity of the self-vehicle, the result of the outside-intersection collision estimation process that is performed when the intersection in-or-our determiner F7 has determined that the self-vehicle exists outside of the intersection area Ar1 in Step S4 for the last time. For the ease of naming, the result of the outside-intersection collision estimation process that is performed when the intersection in-or-our determiner F7 has determined, for the last time, that the self-vehicle exists outside of the intersection area Ar1 in Step S4 may be hereafter designated as a just-before entrance estimation result. The outside-intersection collision estimation process that is performed when the intersection in-or-our determiner F7 has determined, for the last time, that the self-vehicle exists outside of the intersection area Ar1 in Step S4 is equivalent to the outside-intersection collision estimation process that is performed just before the entrance of the self-vehicle into the intersection are Ar1.

Note that adopting the just-before entrance estimation result as the information about the current situation at the proximity of the self-vehicle indicates that a collidable car is identified for a subject intersection that is considered as the front intersection at a just-before timing of entrance of the self-vehicle into the intersection area Ar1.

Since the result of the outside-intersection collision estimation process that is performed by the outside-intersection collision estimator F81 just before the entrance of the self-vehicle into the intersection area Ar1 is stored in the RAM 132, the inside-intersection collision estimator F82 can readily access the RAM 132 and can obtain the information concerned.

In Step S9, the collision estimator F8 provides the notifier F9 with the information about the collidable car obtained by the above-described process, and requests for the notifier F9 to notify the driver of the information about the collidable car. Then, the notifier F9 notifies the driver of the other car that possibly collides with the self-vehicle

According to the above, when the self-vehicle exists outside of the intersection area Ar1, the notifier F9 provides the driver with the information about the collidable car in the intersection into which the self-vehicle is going to enter. When the self-vehicle exists inside of the intersection area Ar1, the notifier F9 provides the driver with the information about the collidable car in the intersection through which the self-vehicle is currently passing.

The information about the collidable car is, as already described in the above, the approaching direction of the collidable car relative to the self-vehicle, the collision type regarding the collision with the self-vehicle, the remaining time to the collision, and the like. Note that the notifier F9 does not have to provide the driver with all of the information mentioned above. In other words, the information to be provided for the driver may be arbitrarily picked and chosen for not confusing the driver and not flooding the driver with too much information.

After completion of the process in Step S9, the flowcharted process is finished.

### Summary of the Embodiment

According to the above configuration, the intersection area specifier F6 specifies the intersection area Ar1 that that corresponds to the front intersection, and the intersection in-or-our determiner F7 determines whether the self-vehicle exists inside of the intersection area Ar1, or exists outside thereof.

When the self-vehicle exists outside of the intersection area Ar1 (Step S4:NO), the outside-intersection collision estimator F81 identifies the collidable car in the front intersection by using the current position of the self-vehicle, the behavior information of the self-vehicle, and the other car information received via the vehicle-to-vehicle communication (Step S7). Then, the notifier F9 performs a drive support for the intersection into which the self-vehicle is going to enter (i.e., front intersection). More specifically, the notifier F9 provides the driver with the information about the other car that may collide with the self-vehicle in the front intersection.

When, thereafter, the intersection in-or-our determiner F7 determines that the self-vehicle has entered into the intersection area Ar1 (Step S4:YES), the collision estimator F8 provides, to the notifier F9, the result of the outside-intersection collision estimation process that is performed by the outside-intersection collision estimator F81 just before the entrance of the self-vehicle into the intersection area Ar1. As a result, the notifier F9 provides the information based on the result of the outside-intersection collision estimation process that is performed by the outside-intersection collision estimator F81 just before the entrance of the self-vehicle into the intersection area Ar1. That is, the contents of the information provided for the driver during a period of passing through the intersection area Ar1 are maintained as (i.e., are kept unchanged from) the same contents as the information provided before entering into the intersection concerned.

After the above, when the intersection in-or-our determiner F7 determines that the self-vehicle has exited the intersection area Ar1 (Step S4:NO), the front intersection is identified again (Step S5), and a subject intersection that is considered as the front intersection is updated as an object of various processes, in other words. The update of the front intersection indicates that the intersection used in Step S705 of FIG. 6 is updated. Therefore, when the front intersection is updated, the information contents notified by the notifier F9 also transition to the information contents about the updated front intersection.

That is, according to the above configuration, when the intersection in-or-our determiner F7 determines that the self-vehicle has entered into the intersection area Ar1, until it is determined that the self-vehicle has exited from the intersection area Ar1, the subject intersection is maintained without being changed from the one that is the object of the various processes before the entrance of the self-vehicle thereinto.

Therefore, during a period of passing through a certain intersection, information provided for the user is substantially prevented from being switched from the one about the currently-passing intersection to a different intersection, is reduced.

As a result, a possibility of confusing the user who is passing through a certain intersection is reduced.

According to the above configuration, the collision estimator F8 identifies the collidable car in the front intersection by using the self-vehicle predicted travel path Ph and the other car predicted travel path Pr. The self-vehicle predicted travel path Ph is calculable from the current position of the self-vehicle, and the behavior information, more specifically from the travel direction, of the self-vehicle. The other car predicted travel path Pr is calculable from the other car information received via the vehicle-to-vehicle communication.

That is, when calculating the collision possibility, it is not necessary to map both the self-vehicle and the other car on the map. Therefore, compared with configuration that requires the mapping of both of the self-vehicle and the other car, the collision possibility can be estimated with smaller calculation load.

Although, in the above, a method of identifying the collidable car in the front intersection by using the self-vehicle predicted travel path Ph and the other car predicted travel path Pr is shown as an example, the identification method for identifying a collidable car is not limited to the method mentioned above. The collidable car in a certain intersection may be identified, for example by publicly-known methods, e.g., the method disclosed in the patent document 1.

Generally, when the self-vehicle exists, is traveling, outside of an intersection, or, when the self-vehicle travels through an intersection straight on, i.e., without turning, a line of the travel direction of the self-vehicle and the road shape highly-likely match with each other. Therefore, the mapping of the self-vehicle onto the road map is performed with a relatively high mapping accuracy. However, when the self-vehicle makes a right/left turn at an intersection, i.e., performs a turning behavior, the line of the travel direction of the self-vehicle and the road shape may not highly match with each other.

As a result, there may be a case that mapping becomes faulty with the low mapping accuracy, or the mapping may be disabled. The disabled mapping indicates that, as a result of the mapping, the output of the current position of a vehicle is undeterminable.

That is, when a vehicle is inside of an intersection, the mapping result may easily go wrong. As a result, in a configuration that uses the map matching result for sequentially identifying a front intersection even when a vehicle is passing through one intersection, the identified intersection may possibly transition to the next intersection even though the vehicle is still passing through the one intersection.

For addressing such a problem, in the present embodiment, after entering into the intersection area Ar1 that corresponds to the front intersection, the subject intersection is maintained as, i.e., is kept unchanged from, the one that is considered as the front intersection just before entering into the intersection area Ar1 concerned. Therefore, a possibility of switching of the subject intersection from one to the other during passing of the one intersection is reduced.

Although, in the present embodiment, a process for identifying a front intersection (i.e., Step S5) will not be performed as the identification procedure when the self-vehicle exists inside of the intersection area Ar1, the identification procedure of a front intersection is not necessarily limited to the above.

Even when the self-vehicle exists inside of the intersection area Ar1, a process for identifying a front intersection may be sequentially performed. However, even in such case, the subject intersection after entering into an intersection that corresponds to the front intersection is maintained as, i.e., is kept unchanged from, the one that is considered as the front intersection just before entering into the intersection area Ar1 concerned.

Further, an above-described example of the present embodiment regarding the present disclosure is not limited to the above description, i.e., may be modified to take various forms, as long as the modifications pertains to the gist of the present disclosure.

Note that the same/similar components as the above-described one have the same numeral, for the brevity of the description. Note that when a part of a configuration is described, the rest of the configuration may be borrowed from the previously-described one.

[Modification 1]

In the embodiment mentioned above, the outside-intersection collision estimator F81 is described as extracting the collidable car in the front intersection depending on whether the path cross point X is within a threshold distance from the node that corresponds to the front intersection. However, such a configuration may be changed.

For example, based on the mapping by the mapper F4 according to the other car information received via the vehicle-to-vehicle communication, the other car traveling toward the front intersection on a road that passes the front intersection may be extracted as a candidate of the collidable car.

[Modification 2]

In the above embodiment, the outside-intersection collision estimator F81 is described as identifying/estimating a collision type based on an angle (i.e., the travel path crossing angle) θ between the self-vehicle predicted travel path Ph and the other car predicted travel path Pr, how the outside-intersection collision estimator F81 estimates the collision type is not necessarily limited to an example of the method mentioned above.

For example, the outside-intersection collision estimator F81 may estimate a collision type according to a road cross angle, i.e., an angle between (i) a self-vehicle travel road identified by the mapper F4 on which the self-vehicle is traveling and (ii) an other car travel road traveled by the collidable car, which is measured at the front intersection. Note that the road cross angle is treated in the same manner as the path cross angle θ, and the collision type may be estimated by using the collision type estimation data. The other car travel road may be identified by the mapper F4, i.e., by mapping the other car based on the other car information received by the vehicle-to-vehicle communication.

[Modification 3]

According to the embodiment mentioned above, the inside-intersection collision estimator F82 is configured to maintain, as is, the result of the outside-intersection collision estimation process that is performed by the outside-intersection collision estimator F81 just before the entrance of the self-vehicle into the intersection area Ar1, the operation of the estimator F82 is not necessarily limited to such an example.

By performing a similar process as the outside-intersection collision estimation process shown in FIG. 6, the inside-intersection collision estimator F82 may also estimate the collision type, while sequentially identifying the collidable car.

However, in such case, the node information used in the extracting process of Step S705 may preferably be set as the node information about the front intersection that is identified by the front intersection identifier F5 before, or, just before, the entrance of the self-vehicle into the intersection area Ar1 Note that the front intersection that is identified by the front intersection identifier F5 before the entrance of the self-vehicle into the intersection area Ar1 is, in other words, an intersection that corresponds to the currently-traveled intersection area Ar1.

Such configuration also enables an estimation of possibility of collision between the self-vehicle and the other car in a subject intersection that is considered as the front intersection at a timing before a determination that, when (i) the self-vehicle is determined as existing inside of the intersection area Ar1 by the intersection in-or-our determiner F7, the self-vehicle exists inside of the intersection area Ar1. According to such configuration, the same effects as the above-described embodiment are achievable.

[Modification 4]

In the modification 3 mentioned above, the inside-intersection collision estimator F82 is described as extracting the collidable car depending on whether the path cross point X is within a threshold distance from the node that corresponds to the intersection area Ar1 which is currently traveled by the self-vehicle. However, the configuration may be from such an example.

For example, the mapper F4 maps the other car based on the other car information received by the vehicle-to-vehicle communication. Then, the inside-intersection collision estimator F82 may extract the other car that is traveling on a road toward the front intersection, when such a road is passing through an intersection that corresponds to the intersection area Ar1 currently traveled by the self-vehicle.

[Modification 5]

Further, in the modification 3 mentioned above, the inside-intersection collision estimator F82 is described as estimating the collision type by using the path cross angle θ. However, how the inside-intersection collision estimator F82 estimates the collision type with the other car is not limited to the method mentioned above.

For example, the inside-intersection collision estimator F82 may estimate the collision type according to the road cross angle between the self-vehicle travel road that is traveled by the self-vehicle before the entrance into the intersection area Ar1 and the other car travel road that is traveled by the collidable car.

The road traveled by the self-vehicle before the entrance into the intersection area Ar1 is the self-vehicle travel road that is identified by the mapper F4 before the entrance of the self-vehicle into the intersection area Ar1. Further, the road traveled by the other car may be identified by mapping the other car based on the other car information received by the vehicle-to-vehicle communication.

The road cross angle may be treated in the same manner as the path cross angle θ, and the collision type may be estimated by using the collision type estimation data.

[Modification 6]

In the embodiment mentioned above, the intersection area Ar1 is identified based on the positions of the points C12, C23, C34, C41 that are defines as intersections of the road edges at the subject intersection. However, the configuration may be changed from such an example.

For example, as shown in FIG. 9, the intersection area Ar1 may be defined as a square area with an element length of Dx and centering on the node N1. The direction of such a square shape intersection area Ar1 may be defined as, for example, a direction of a pair of two elements perpendicular to the travel direction of the self-vehicle.

The length Dx of the elements may be a fixed value, or may be a value adjusted based on the road width of the connecting links of the node N1, the number of the connecting links of the node N1, and/or the number of total traffic lanes in the connecting links, or the like.

For example, the length Dx of the elements may be defined as a value in proportion to the maximum road width among the connecting links of the node N1. In such case, the length Dx is set to have a greater value as the road width of the link increases.

Further, the length Dx may be set to have a greater value as the number of the connecting links of the node N1 increases, or as the number of total traffic lanes increases. This is because, the greater the number of the connecting links or the number of total traffic lanes is, the subject intersection is suggested as having a larger intersection area.

Note that the intersection area Ar1 may not only have the square shape, but also a rectangular shape, a hexagonal shape, an octagonal shape, a polygonal shape, or the like. Further, the intersection area Ar1 may have a circular shape, as described in the embodiment. Furthermore, the intersection area Ar1 may have an oval shape, or may have a shape that is made up as a combination of curves and straight lines. As for the shape of the intersection area Ar1, it is preferable that the area Ar1 has a shape that corresponds to an actual road surface area that functions as an intersection.

[Modification 7]

In the above, the intersection area specifier F6 is described as identifying the intersection area by using the map data stored in the map storage 60. However, the intersection area specifier F6 is not necessarily limited to such an example.

For example, if a roadside device disposed at a proximity of an intersection is configured to deliver the map data around the intersection, the intersection area may be identified by using the delivered map data delivered from the roadside device and received by the short-range radio communicator 12.

Further, for example, the roadside device disposed at the intersection is configured to deliver the data of the relevant intersection (i.e., intersection area data), the intersection area may be identified by using the delivered intersection area data delivered from the roadside device and received by the short-range radio communicator 12.

Furthermore, the source of delivery of the map data or the intersection area data is not necessarily limited to the roadside device. The data may be delivered from the other car, or from the data center when the roadside device is connected to a wide area network. Further, for receiving the data from the data center, the drive support apparatus 10 is assumed to be equipped with a communication module for connecting with the wide area network.

Furthermore, when the in-vehicle system 1 is equipped with a device for recognizing an environment of the self-vehicle including a front field thereof, such as a camera, a laser radar or the like, a recognition result of the environmental recognition device may be used for identifying the intersection area.

Although the present disclosure has been described in connection with preferred embodiment thereof with reference to the accompanying drawings, it is to be noted that various changes and modifications will become apparent to those skilled in the art, and such changes, modifications, and summarized schemes are to be understood as being within the scope of the present disclosure as defined by appended claims.

What is claimed is:

1. A drive support apparatus used in a self-vehicle comprising:
a Vehicle-to-Vehicle (V2V) communicator performing a vehicle-to-vehicle communication with other car that exists around the self-vehicle;
a self-vehicle position specifier specifying a current position of the self-vehicle based on navigation signals transmitted from a navigation satellite;
an other car information obtainer obtaining other car information indicative of a current position, a travel direction and a travel speed of the other car via the V2V communicator;
a mapper identifying a position of the self-vehicle on a road map that shows a connection relationship of roads, based on the current position of the self-vehicle specified by the self-vehicle position specifier;
a front intersection identifier identifying a front intersection to be traveled by the self-vehicle based on an identification result of the mapper;
an intersection area specifier specifying an intersection area of the front intersection that is identified by the front intersection identifier;
an intersection in-or-out determiner determining sequentially whether the self-vehicle exists inside of the intersection area or outside of the intersection area of the front intersection, based on a comparison between (i) the current position of the self-vehicle specified by the self-vehicle position specifier and (ii) the intersection area of the front intersection specified by the intersection area specifier; and
a collidable car identifier identifying a collidable car that may possibly collide with the self-vehicle in a specific intersection, based on (i) the current position of the self-vehicle specified by the self-vehicle position specifier and (ii) the other car information obtained by the other car information obtainer, wherein
(A) the collidable car identifier identifies the collidable car in the front intersection, when the intersection in-or-out determiner determines that the self-vehicle exists outside of the front intersection, and
(B) the collidable car identifier identifies the collidable car in an intersection that has been identified as the front intersection by the front intersection identifier, when the intersection in or out determiner determines that the self vehicle exists inside of the area boundary of the front intersection, at a timing before a determination by the intersection in-or-out determiner that the self-vehicle exists inside of the front intersection.

2. The drive support apparatus of claim 1, further comprising:
a behavior information obtainer obtaining, as behavior information of the self-vehicle, a travel direction and a vehicle speed of the self-vehicle;
a self-vehicle predictor predicting a travel path of the self-vehicle in a future, based on (i) the current position of the self-vehicle specified by the self-vehicle position specifier and (ii) the behavior information obtained by the behavior information obtainer;
another car predictor predicting a travel path of the other car based on the other car information obtained by the other car information obtainer, wherein
the collidable car identifier
i) identifies the collidable car based on a predicted crossing between the travel path of the self-vehicle and the travel path of the other car, and
ii) estimates a type of collision between the self-vehicle and the collidable car based on a crossing path angle between the travel path of the other car and the travel path of the self-vehicle.

3. The drive support apparatus of claim 1, wherein
the mapper
i) identifies a travel road of the self-vehicle currently traveled by the self-vehicle, based on a current position of the self-vehicle on the road map,
ii) identifies a current position of the other car on the road map, based on the other car information obtained by the other car information obtainer, and
iii) identifies a travel road of the other car currently traveled by the other car, based on the current position of the other car on the road map, and
the collidable car identifier
iv) identifies the collidable car, based on the travel road of the other car being connected to the front intersection, and
v) estimates a type of collision between the self-vehicle and the collidable car, based on a crossing road angle between the travel road of the other car, and the travel road of the self-vehicle.

4. The driver support apparatus of claim 3, wherein
the collidable car identifier estimates the type of collision between the self-vehicle and the collidable car, when the intersection in-or-out determiner is determining that the self-vehicle is currently in the area boundary of the front intersection, based on a crossing angle between (i) the travel road of the self-vehicle and (ii) the travel road of the collidable car, which have already been specified before an entrance of the self-vehicle into the area boundary of the front intersection.

5. The driver support apparatus of claim 1, wherein
the collidable car identifier updates the front intersection that is a subject of a determination about the collidable car, when the intersection in-or-out determiner determines that the self-vehicle has exited from the area boundary of the front intersection.

6. The driver support apparatus of claim 1, wherein
the front intersection identifier identifies the front intersection, when the intersection in-or-out determiner determines that the self-vehicle is currently out of the front intersection.

7. The driver support apparatus of claim 1 further comprising:
a notifier performing a process that notifies, via a preset information providing device, the driver of information about the collidable car that is identified by the collidable car identifier.
